(19) United States
(12) Patent Application Publication
(10) Pub. No.: US 2019/0103816 A1
(43) Pub. Date: Apr. 4, 2019

(54) POWER CONVERSION DEVICE AND VOLTAGE REGULATING FEEDBACK CIRCUIT

(71) Applicant: DELTA ELECTRONICS, INC., Taoyuan City (TW)

(72) Inventors: Chi-You KO, Taoyuan City (TW); Wei-Chieh CHAO, Taoyuan City (TW)

(21) Appl. No.: 15/939,265

(22) Filed: Mar. 28, 2018

(30) Foreign Application Priority Data
Sep. 29, 2017 (CN) 201710906982.4

(51) Int. Cl. H02M 3/335

(52) U.S. Cl. CPC H02M 3/33523

(57) ABSTRACT

A power conversion device includes a transformer having a primary winding and a secondary winding, a switch coupled between the primary winding and a primary ground, a control circuit configured to output a control signal to turn on or off the switch selectively, a secondary circuit coupled to the secondary winding and configured to output an output voltage, a voltage regulating feedback circuit coupled to the secondary circuit, and an isolation circuit coupled between the voltage regulating feedback circuit and the control circuit. On the condition that the output voltage is greater than an upper limit, the voltage regulating feedback circuit is configured to output a feedback signal via the isolation circuit to the control circuit such that the control circuit turns off the switch.

### RELATED APPLICATIONS

This application claims priority to China Application Serial Number 201710906982.4, filed Sep. 29, 2017, which is herein incorporated by reference.

### BACKGROUND

### Technical Field

The present disclosure relates to a power conversion device, and in particular, to the power conversion device applying a switching power converter structure.

### Description of Related Art

Recently, many electronic devices and driving circuits use the switching power supplies to provide electricity. When the power requested by the latter stage load varies and causes the power supply being at an empty load state, the output voltage of the power supply lifts up, and thus the related safety regulation will be violated.

### SUMMARY

One aspect of the present disclosure is a power conversion device. The power conversion device includes a transformer having a primary winding and a secondary winding, a switch coupled between the primary winding and a primary ground, a control circuit configured to output a control signal to turn on or off the switch selectively, a secondary circuit coupled to the secondary winding and configured to output an output voltage, a voltage regulating feedback circuit coupled to the secondary circuit, and an isolation circuit coupled between the voltage regulating feedback circuit and the control circuit. On the condition that the output voltage is greater than an upper limit, the voltage regulating feedback circuit is configured to output a feedback signal via the isolation circuit to the control circuit such that the control circuit turns off the switch.

Another aspect of the present disclosure is a voltage regulating feedback circuit. The voltage regulating feedback circuit includes a first diode unit, a Zener diode unit, and a first voltage dividing unit. An anode of the first diode unit is configured to receive an output voltage outputted by an output terminal of a power conversion device. A cathode of the Zener diode unit is electrically coupled to a cathode of the first diode unit. The first voltage dividing unit is electrically coupled to an anode of the Zener diode unit and an isolation circuit. On the condition that the output voltage of the power conversion device is greater than an upper limit, the Zener diode unit reversely breakdowns such that a first current flows through a secondary side of the isolation circuit and a primary side of the isolation circuit conducts accordingly to provide the feedback signal to a primary side of the power conversion device in order to reduce the output voltage.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a diagram illustrating a power conversion device according to some embodiments of the present disclosure.

FIG. 2 is a diagram illustrating the operation of the power conversion device according to some embodiments of the present disclosure.

FIG. 3 is a diagram illustrating the power conversion device according to some other embodiments of the present disclosure.

FIG. 4 is a diagram illustrating the power conversion device according to some embodiments of the present disclosure.

FIG. 5 is a diagram illustrating the power conversion device according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

In the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

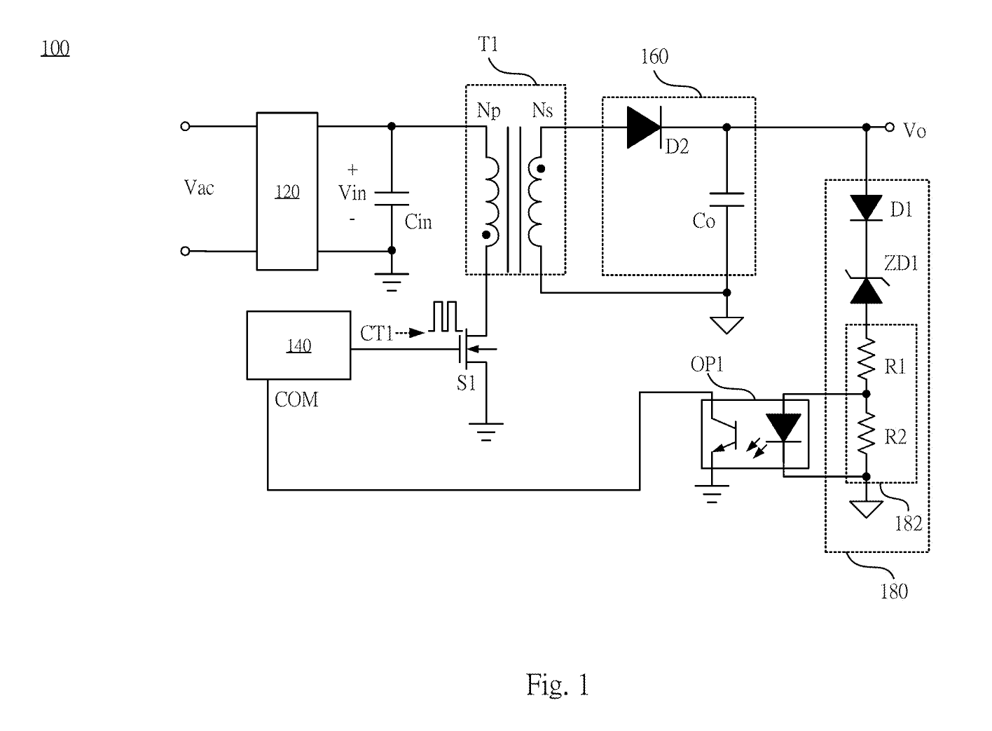

Reference is made to FIG. 1. FIG. 1 is a diagram illustrating a power conversion device 100 according to some embodiments of the present disclosure. As shown in FIG. 1, in some embodiments, the power conversion device 100 includes a rectifying circuit 120, a transformer T1, a switch S1, a control circuit 140, a secondary circuit 160, a voltage regulating feedback circuit 180, and an isolation circuit OP1.

As shown in FIG. 1, the power conversion device 100 is configured to receive an AC voltage Vac and convert the AC voltage Vac to an output voltage Vo, and then output the output voltage Vo to a latter load via an output terminal of the power conversion device 100. The rectifying circuit 120 is configured to receive the AC voltage Vac via its input terminal, and convert the AC voltage Vac to a DC voltage Vin and output to two terminals of a capacitor unit Cin via its output terminal.

The transformer T1 includes a primary winding Np and a secondary winding Ns. At a primary side of the transformer T1, a first terminal of the primary winding Np is electrically coupled to the output terminal of the rectifying circuit 120. A first terminal of the switch S1 is electrically coupled to the a second terminal of the primary winding Np, and a second terminal of the switch S1 is electrically coupled to a primary ground. The control circuit 140 is electrically coupled to a control terminal of the switch S1 and configured to output a control signal CT1 to turn on or off the switch S1 selectively.

On the other hand, at a secondary side of the transformer T1, the secondary winding Ns is electrically coupled to the secondary circuit 160. Thus, the transformer T1, the switch S1 and the secondary circuit 160 may work as an isolated high frequency DC-DC power converter circuit to convert the dc voltage Vin to the output voltage Vo.

Specifically, as shown in FIG. 1, in some embodiments, the secondary circuit 160 includes a diode unit D2 and an output capacitor unit Co. An anode of the diode unit D2 is electrically coupled to the secondary winding Ns. A first terminal of the output capacitor unit Co is electrically coupled to a cathode of the diode unit D2 and the voltage regulating feedback circuit 180, and a second terminal of the output capacitor unit Co is electrically coupled to a secondary ground.

In operation, the control circuit 140 may output a pulse width modulation (PWM) signal as the control signal CT1, and control amplitude of the output voltage Vo by adjusting a duty cycle of the control signal CT1.

On the condition that an electricity loop is formed when the switch S1 is on, a primary current flows through the primary winding Np of the transformer T1, such that the power is stored in the primary winding Np. Since a polarity of the primary winding Np and a polarity of the secondary winding Ns are opposite, at the time the diode unit D2 in the secondary circuit 160 is in reversed bias and does not transmit power to the load. The power conversion device 100 is configured to provide the output voltage Vo required by the latter circuit from the power stored in the output capacitor unit Co in the secondary circuit 160.

On the condition that the switch S1 is off and the electricity loop is disconnected, the polarities of the primary winding Np and of the secondary winding Ns reverse such that the diode unit D2 conducts, and the power stored in the transformer T1 is transferred to the secondary side and output to the latter stage circuit and the output capacitor unit Co. Since a ratio of the power conversion is correlated to turns ratio of the transformer T1 and the duty cycle, the control circuit 140 may control amplitude of the output voltage Vo by adjusting the duty cycle of the control signal CT1.

In some embodiments, on the condition that the output of the power conversion device is at empty load, the voltage level of the output voltage Vo at the output terminal will uplift. For example, in the embodiments with the output voltage Vo having rated output at about 55V, under an empty load circumstance, the output voltage Vo may uplift and exceed 60V, causing that the safety level regulated in the safety extra low voltage (SELV) is exceeded. Accordingly, the power conversion device 100 may, by the co-operation of the voltage regulating feedback circuit 180 and the isolation circuit OP1, guarantee that the output voltage Vo will not be greater than an upper limit (e.g., 60V), and regulate the output voltage Vo at a target voltage level.

The voltage regulating feedback circuit 180 is electrically coupled to the secondary circuit 160 at the output terminal of the power conversion device 100. The isolation circuit OP1 is electrically coupled between the voltage regulating feedback circuit 180 and a pin COM of the control circuit 140.

As shown in FIG. 1, in some embodiments, the voltage regulating feedback circuit 180 includes a diode unit D1, a Zener diode unit ZD1, and a voltage dividing unit 182. An anode of the diode unit D1 is electrically coupled to the output terminal of the secondary circuit 160. A cathode of the diode unit D1 is electrically coupled to a cathode of the Zener diode unit ZD1. The voltage dividing unit 182 is electrically coupled to an anode of the Zener diode unit ZD1, the secondary side of the isolation circuit OP1, and the secondary ground.

Specifically, in some embodiments, the voltage dividing unit 182 includes voltage dividing resistors R1 and R2. A first terminal of the voltage dividing resistor R1 is electrically coupled to the anode of the Zener diode unit ZD1. A second terminal of the voltage dividing resistor R1 is electrically coupled to a first input terminal of the secondary side of the isolation circuit OP1. A first terminal of the voltage dividing resistor R2 is electrically coupled to the second terminal of the voltage dividing resistor R1. A second terminal of the voltage dividing resistor R2 is electrically coupled to a second input terminal of the secondary side of the isolation circuit OP1.

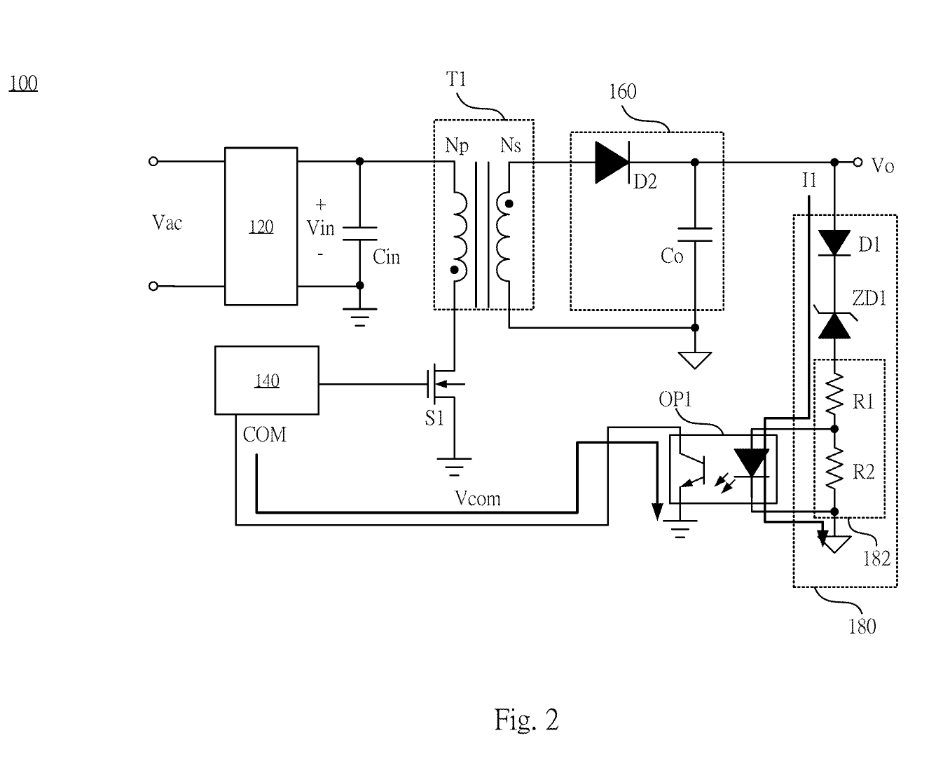

For better understanding of operations of the voltage regulating feedback circuit 180 and the isolation circuit OP1, reference is made to FIG. 2. FIG. 2 is a diagram illustrating the operation of the power conversion device 100 according to some embodiments of the present disclosure.

As shown in FIG. 2, a Zener diode with proper reverse breakdown voltage (e.g., 60V) may be chosen to implement the Zener diode unit ZD1 in the voltage regulating feedback circuit 180. Thus, on the condition that the output voltage Vo is greater than the upper limit, the Zener diode unit ZD1 reversely breakdowns and form an electricity loop such that a current 11 flows through the secondary side of the isolation circuit OP1, and the primary side of the isolation circuit OP1 conducts accordingly to provide the feedback signal Vcom to the pin COM of the control circuit 140. Thus, on the condition that the output voltage Vo is greater than the upper limit (e.g., 60V), the voltage regulating feedback circuit 180 may be configured to output the feedback signal Vcom via the isolation circuit OP1 to the control circuit 140 such that the control circuit 140 turns off the switch S1.

In some embodiments, the diode unit D1 may be configured to prevent the current flows reversely to the output terminal of the power conversion device 100, so as to avoid damaging to the power conversion device 100 or the latter stage load. Similarly, the voltage dividing resistors R1 and R2 may be chosen from electronic elements with proper resistance value in order to adjust amplitude of the current 11 flowing through the secondary side of the isolation circuit OP1.

Thus, when the current 11 flows through the secondary side of the isolation circuit OP1, the isolation circuit OP1 may correspondingly conduct the electricity loop at the primary side according to the current 11, such as conducting a phototransistor inside the isolation circuit OP1 in order to transmit the signal to the primary side and pull low the voltage level of the pin COM of the control circuit 140 such that the voltage level of the pin COM is lower than the lowest operation voltage.

Specifically, the isolation circuit OP1 may be realized by a photo-coupler device with proper Current-Transfer-Ratio (CTR) and arranged with proper voltage dividing resistors R1 and R2 according to the Current-Transfer-Ratio.

For example, in some embodiments, the voltage dividing resistor R2 may choose a resistor with large resistance such that the current flowing through the voltage dividing resistor R2 may be neglected. The current 11 flowing through the secondary side of the isolation circuit OP1 may be described as the following equation:

$$I 1 = \frac{Vo - {V}_{ZD 1} - {V}_{D 1}}{R 1}$$

V_{ZD1} denotes the voltage across the Zener diode unit ZD1, V_{D1} denotes the voltage across the diode unit D1 during forward conduction. Thus, the voltage regulating feedback circuit 180 may apply the voltage dividing resistors R1 and R2 with proper resistance values in accompanying with the Current-Transfer-Ratio of the isolation circuit OP1 to adjust the current amplitude for both sides of the isolation circuit OP1 and provide proper pull down current at the primary side to pull low the voltage level of the pin COM.

Thus, the control circuit 140 is configured to enter a protection mode and stop outputting the pulse width modulation control signal CT1 to the switch S1, and the switch S1 is off correspondingly. Accordingly, the output voltage Vo of the power conversion device 100 will reduce gradually to ensure that the output voltage Vo will not exceed the upper limit (e.g., 60V) configured based on the safety requirements, in order to satisfy the safety specification.

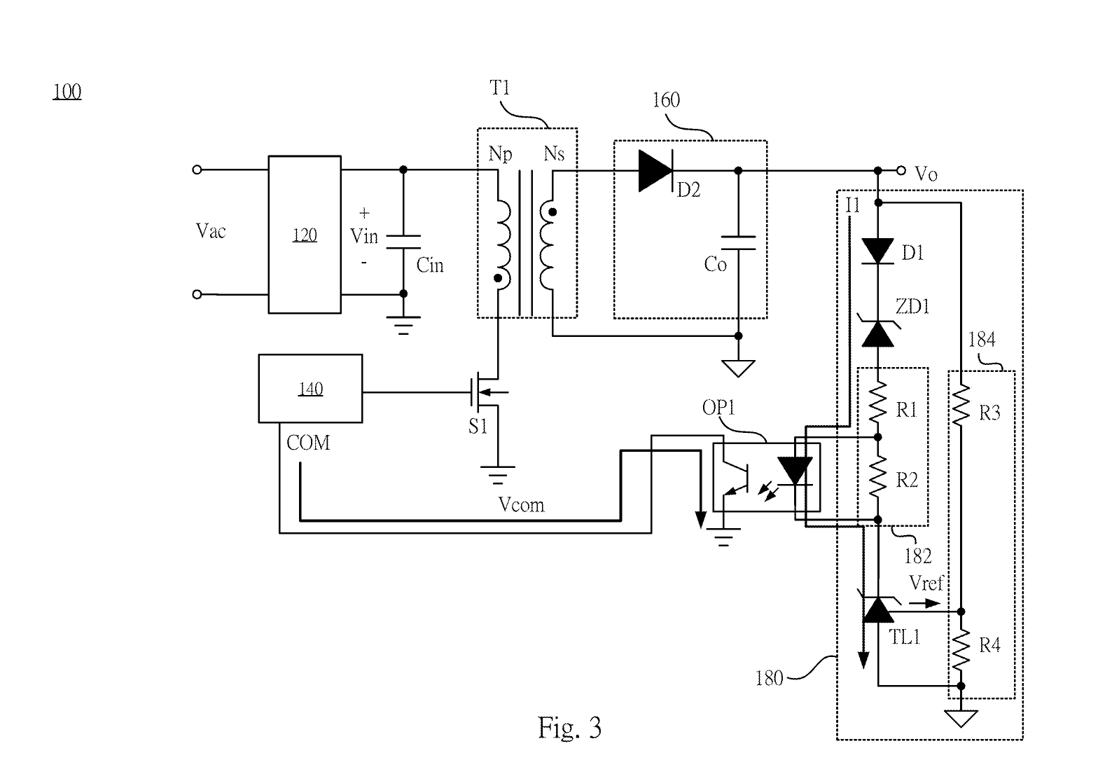

Reference is made to FIG. 3. FIG. 3 is a diagram illustrating the power conversion device 100 according to some other embodiments of the present disclosure. As shown in FIG. 3, in some embodiments, the voltage regulating feedback circuit 180 further includes a voltage dividing unit 184 and a voltage regulating unit TL1. The voltage dividing unit 184 is electrically coupled between the secondary circuit 160 and the secondary ground. A cathode of the voltage regulating unit TL1 is electrically coupled to a second input terminal of the secondary side of the isolation circuit OP1. An anode of the voltage regulating unit TL1 is electrically coupled to the secondary ground. A reference terminal of the voltage regulating unit TL1 is electrically coupled to the voltage dividing unit 184.

Specifically, the voltage dividing unit 184 includes voltage dividing resistors R3 and R4. A first terminal of the voltage dividing resistor R3 is electrically coupled to the output terminal of the secondary circuit 160. A second terminal of the voltage dividing resistor R3 is electrically coupled to the reference terminal of the voltage regulating unit TL1. A first terminal of the voltage dividing resistor R4 is electrically coupled to the second terminal of the voltage dividing resistor R3, and a second terminal of the voltage dividing resistor R4 is electrically coupled to the secondary ground.

In some embodiments, the voltage regulating unit TL1 may be configured to adjust the first current 11 according to the reference voltage Vref at the reference terminal using the voltage dividing unit 182, in order to control a voltage level of the output voltage Vo. Specifically, as shown in FIG. 3, the voltage regulating unit TL1 may be a three-terminal adjustable shunt regulator. On the condition that the voltage of the reference terminal of the voltage regulating unit TL1 is about equal to its reference value (e.g., about 2.5V), a stable current 11 flows through the voltage regulating unit TL1. If the current voltage of the reference terminal is away from the reference value (e.g., about 2.5V), the current 11 flowing through the voltage regulating unit TL1 rises or falls accordingly. Thus, by a negative feedback circuit design, the voltage regulating unit TL1 may ensure the voltage level of the reference voltage Vref is stabled at the reference value (e.g., about 2.5V).

Thus, by selecting the voltage dividing resistor R1 with proper resistance value and the isolation circuit OP1, the current 11 flowing through the voltage regulating unit TL1 may satisfy the activation current (e.g., 1 ma) required by the voltage regulating unit TL1 when the output voltage Vo is greater than the upper limit and resulting the Zener diode unit ZD1 to reversely breakdown, such that the voltage regulating unit TL1 activates the current-shunting mechanism in order to control the reference voltage Vref of the reference terminal stabled at the reference value (e.g., 2.5V).

Since the voltage dividing unit 184 is configured to perform voltage division by voltage dividing resistors R3 and R4, there is a ratio relationship between the reference voltage Vref and the output voltage Vo, and thus the voltage level of the output voltage is stabled at the corresponding voltage level as the stable reference voltage Vref is provided by the voltage regulating unit TL1. For example, if the reference value of the voltage regulating unit TL1 is 2.5 V, and the target value of the output voltage Vo is 55V, the proper voltage dividing resistors R3 and R4 may be chosen in order to satisfy the following equation:

$$\frac{R 4}{R 3 + R 4} = \frac{2.5}{55}$$

Therefore, by selecting the voltage dividing resistors R3 and R4 with proper resistance values accordingly, it may be further guaranteed that the output voltage Vo is controlled at the target voltage level (e.g., 55V). Thus, the power conversion device 100 may supply stable output voltage Vo to the latter load.

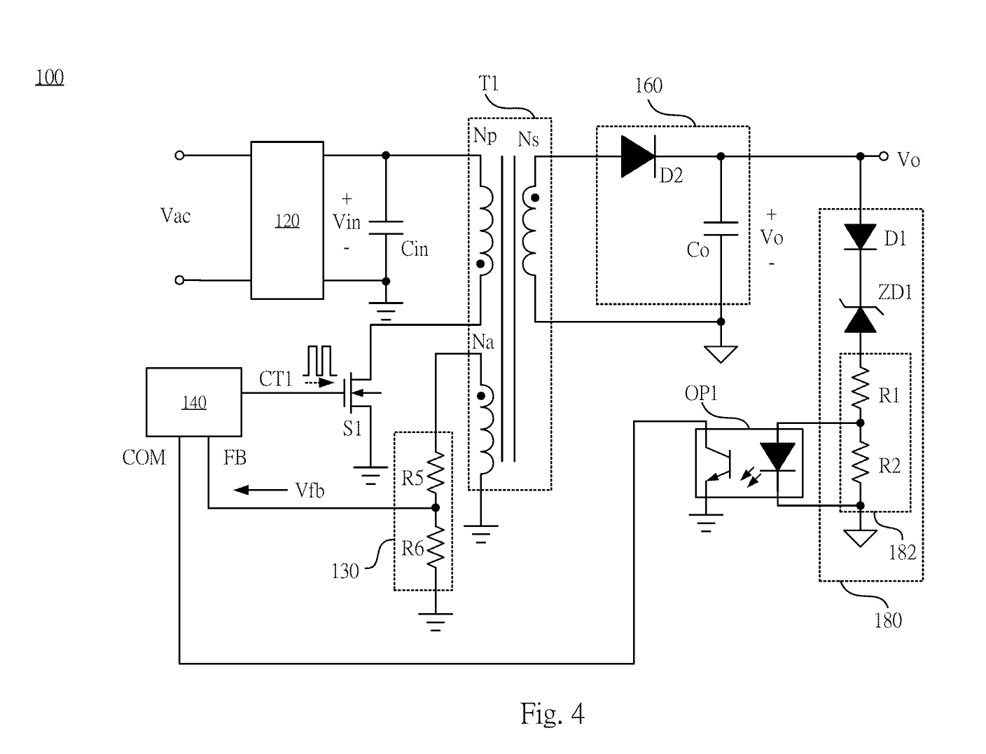

Reference is made to FIG. 4. FIG. 4 is a diagram illustrating the power conversion device 100 according to some embodiments of the present disclosure. As shown in FIG. 4, in some embodiments, the transformer T1 further includes an auxiliary winding Na. The power conversion device 100 further includes a voltage dividing unit 130. The voltage dividing unit 130 is electrically coupled to a first terminal of the auxiliary winding Na and the primary ground.

In some embodiments, the voltage dividing unit 130 is configured to output a feedback voltage Vfb to the pin FB of the control circuit 140, such that the control circuit 140 adjusts a duty cycle of the control signal CT1 according to the feedback voltage Vfb.

Specifically, the voltage dividing unit 130 includes voltage dividing resistors R5 and R6. A first terminal of the voltage dividing resistor R5 is electrically coupled to the auxiliary winding Na, a second terminal of the voltage dividing resistor R5 is electrically coupled to the pin FB of the control circuit 140. A first terminal of the voltage dividing resistor R6 is electrically coupled to the second terminal of the voltage dividing resistor R5, and a second terminal of the voltage dividing resistor R6 is electrically coupled to the primary ground. Thus, the voltage dividing unit 130 may perform voltage division to the voltage of the auxiliary winding Na in order to provide the feedback voltage.

Accordingly, on the condition that the output voltage Vo does not exceed the upper limit and the voltage level of the pin COM of the control circuit 140 is not pulled low by the pull low current, the control circuit 140 may perform feedback control by the feedback voltage Vfb corresponding to the voltage of the auxiliary winding Na at the primary side, to increase or decrease the duty cycle of the control signal CT1 to output the output voltage Vo with proper voltage level. Thus, in the normal operating state, the power conversion device 100 may adjust the control signal CT1 without the feedback of the sampling signal of the output voltage Vo from the secondary side to the primary side.

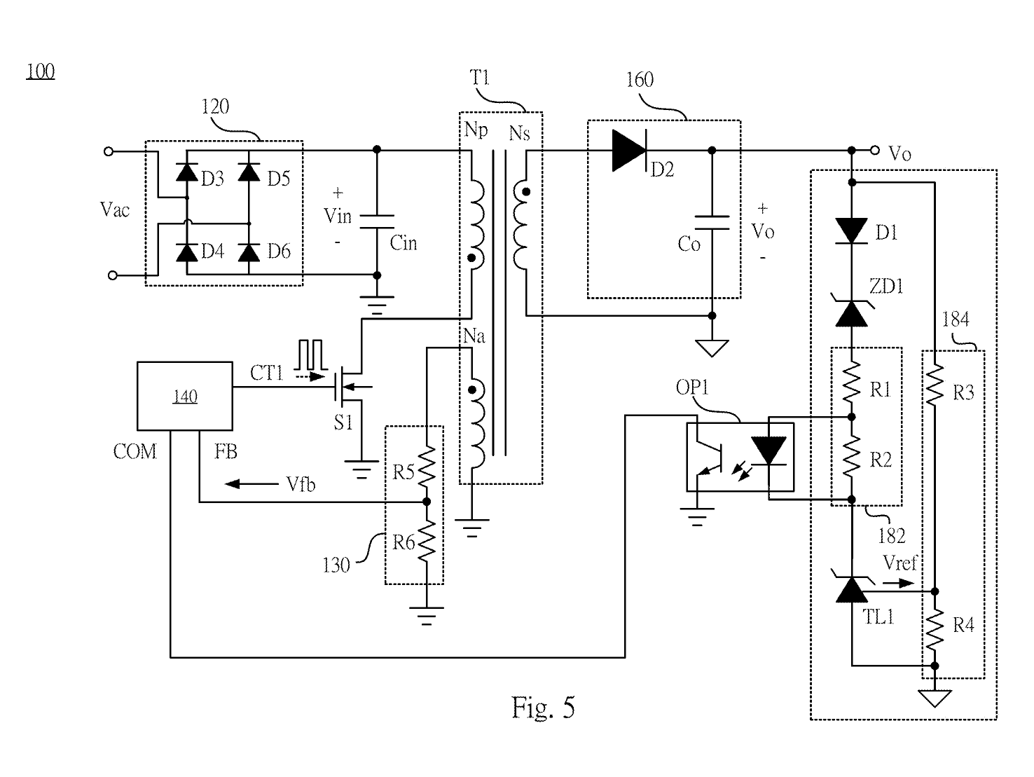

Reference is made to FIG. 5. FIG. 5 is a diagram illustrating the power conversion device 100 according to some embodiments of the present disclosure. As shown in FIG. 5, in some embodiments, the rectifying circuit 120 may be realized by various bridge rectifying circuits.

For example, the rectifying circuit 120 may include a bridge circuit formed by diode units D3, D4, D5, and D6. Specifically, an anode of the diode unit D3 is electrically coupled to a first input terminal of the AC voltage Vac, and a cathode of the diode unit D3 is electrically coupled to a first terminal of the capacitor unit Cin. An anode of the diode unit D4 is electrically coupled to a second terminal of the capacitor unit Cin, and a cathode of the diode unit D4 is electrically coupled to the anode of the diode unit D3. An anode of the diode unit D5 is electrically coupled to a second input terminal of the AC voltage Vac, and a cathode of the diode unit D5 is electrically coupled to the first terminal of the capacitor unit Cin. An anode of the diode unit D6 is electrically coupled to the second terminal of the capacitor unit Cin, and a cathode of the diode unit D6 is electrically coupled to the anode of the diode unit D5.

Thus, the rectifying circuit 120 may receive the AC voltage Vac, perform rectification to the AC voltage Vac by the diode units D3, D4, D5 and D6, and filter the rectified voltage signal by the capacitor unit Cin in order to output the DC voltage Vin.

In addition, as shown in FIG. 5, the features and circuits in the various embodiments FIG. 1-FIG. 4 in the present disclosure may be combined with each other as long as no contradiction appears. The circuits illustrated in the drawings are merely examples and simplified for the simplicity and the ease of understanding, but not meant to limit the present disclosure.

In summary, in various embodiments of the present disclosure, the power conversion device 100 may generate the current 11 flowing through the secondary side of the isolation circuit OP1 on the condition that the output voltage Vo is greater than the upper limit by the Zener diode unit ZD1 and the voltage dividing unit 182 in the voltage regulating feedback circuit 180. Thus, the isolation circuit OP1 may correspondingly provide the feedback signal Vcom to the control circuit 140 at the primary side, in order to pull low the voltage level of the pin COM of the control circuit. Thus. the control circuit 140 may enter a protection mode and stop outputting the pulse width modulation signal such that the switch S1 is turned off correspondingly and thus lowering the output voltage Vo, in order to meet the specification of the safety requirement. In addition, in some embodiments, the voltage regulating feedback circuit 180 may further keep the output voltage Vo at the target voltage level by the cooperation of the voltage dividing unit 184 and the voltage regulating unit TL1, and achieve the effect of stabilize the voltage output.

Although the disclosure has been described in considerable detail with reference to certain embodiments thereof, it will be understood that the embodiments are not intended to limit the disclosure. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A power conversion device comprising:
a transformer comprising a primary winding and a secondary winding;
a switch electrically coupled between the primary winding and a primary ground;
a control circuit configured to output a pulse width modulation control signal to turn on or off the switch selectively;
a secondary circuit electrically coupled to the secondary winding and configured to output an output voltage;
a voltage regulating feedback circuit electrically coupled to the secondary circuit; and
an isolation circuit electrically coupled between the voltage regulating feedback circuit and the control circuit;
wherein on the condition that the output voltage is greater than an upper limit, the voltage regulating feedback circuit is configured to output a feedback signal via the isolation circuit to the control circuit such that the control circuit slops outputting the pulse width modulation control signal and turns off the switch.

2. The power conversion device of claim 1, wherein the voltage regulating feedback circuit comprises a Zener diode unit, and on the condition that the output voltage is greater than the upper limit, the Zener diode unit reversely breakdowns such that a first current flows through a secondary side of the isolation circuit, and a primary side of the isolation circuit conducts accordingly to provide the feedback signal to the control circuit.

3. The power conversion device of claim 2, wherein the voltage regulating feedback circuit further comprises:
a first diode unit, wherein an anode of the first diode unit is electrically coupled to the secondary circuit and a cathode of the first diode unit is electrically coupled to a cathode of the Zener diode unit; and
a first voltage dividing unit electrically coupled to an anode of the Zener diode unit and the secondary side of the isolation circuit.

4. The power conversion device of claim 3, wherein the first voltage dividing unit comprises:
a first voltage dividing resistor, a first terminal of the first voltage dividing resistor being electrically coupled to the anode of the Zener diode unit, a second terminal of the first voltage dividing resistor being electrically coupled to a first input terminal of the secondary side of the isolation circuit; and
a second voltage dividing resistor, a first terminal of the second voltage dividing resistor being electrically coupled to the second terminal of the first voltage dividing resistor, a second terminal of the second voltage dividing resistor being electrically coupled to a second input terminal of the secondary side of the isolation circuit.

5. The power conversion device of claim 3, wherein the voltage regulating feedback circuit further comprises:
a voltage regulating unit, a cathode of the voltage regulating unit being electrically coupled to a second input terminal of the secondary side of the isolation circuit, an anode of the voltage regulating unit being electrically coupled to a secondary ground, and a reference terminal of the voltage regulating unit being configured to provide a reference voltage; and
a second voltage dividing unit electrically coupled between the secondary circuit and the secondary ground, and electrically coupled to the reference terminal of the voltage regulating unit.

6. The power conversion device of claim 5, wherein the voltage regulating unit is configured to control a voltage level of the output voltage according to the reference voltage.

7. The power conversion device of claim 5, wherein the second voltage dividing unit comprises:
a third voltage dividing resistor, a first terminal of the third voltage dividing resistor being electrically coupled to the secondary circuit, a second terminal of the third voltage dividing resistor being electrically coupled to the reference terminal of the voltage regulating unit; and
a fourth voltage dividing resistor, a first terminal of the fourth voltage dividing resistor being electrically coupled to the second terminal of the third voltage dividing resistor, a second terminal of the fourth voltage dividing resistor being electrically coupled to the secondary ground.

8. The power conversion device of claim 2, wherein the transformer further comprises an auxiliary winding, and the power conversion device further comprises:
a third voltage dividing unit electrically coupled between the auxiliary winding and the primary ground, and configured to output a feedback voltage to the control circuit, such that the control circuit adjusts a duty cycle of the pulse width modulation control signal according to the feedback voltage.

9. The power conversion device of claim 8, wherein the third voltage dividing unit comprises:
a fifth voltage dividing resistor, a first terminal of the fifth voltage dividing resistor being electrically coupled to the auxiliary winding, a second terminal of the fifth voltage dividing resistor being electrically coupled to the control circuit; and
a sixth voltage dividing resistor, a first terminal of the sixth voltage dividing resistor being electrically coupled to the second terminal of the fifth voltage dividing resistor, a second terminal of the sixth voltage dividing resistor being electrically coupled to the primary ground.

10. The power conversion device of claim 1, wherein the secondary circuit comprises:
a second diode unit, wherein an anode of the second diode unit is electrically coupled to the secondary winding; and
an output capacitor unit, a first terminal of the output capacitor unit being electrically coupled to a cathode of the second diode unit and the voltage regulating feedback circuit, and a second terminal of the output capacitor unit being electrically coupled to a secondary ground.

11. A voltage regulating feedback circuit comprising:
a first diode unit, wherein an anode of the first diode unit is configured to receive an output voltage outputted by an output terminal of a power conversion device;
a Zener diode unit, wherein a cathode of the Zener diode unit is electrically coupled to a cathode of the first diode unit; and
a first voltage dividing unit electrically coupled to an anode of the Zener diode unit and an isolation circuit;
wherein on the condition that the output voltage of the power conversion device is greater than an upper limit, the Zener diode unit reversely breakdowns such that a first current flows through a secondary side of the isolation circuit and a primary side of the isolation circuit conducts accordingly to provide a feedback signal to a primary side of the power conversion device in order that the power conversion device stops outputting a pulse width modulation control signal and turn off a switch of the power conversion device to as to reduce the output voltage.

12. The voltage regulating feedback circuit of claim 11, wherein the first voltage dividing unit comprises:
a first voltage dividing resistor, a first terminal of the first voltage dividing resistor being electrically coupled to the anode of the Zener diode unit, a second terminal of the first voltage dividing resistor being electrically coupled to a first input terminal of the secondary side of the isolation circuit; and
a second voltage dividing resistor, a first terminal of the second voltage dividing resistor being electrically coupled to the second terminal of the first voltage dividing resistor, a second terminal of the second voltage dividing resistor being electrically coupled to a second input terminal of the secondary side of the isolation circuit.

13. The voltage regulating feedback circuit of claim 11, further comprising:
a voltage regulating unit, a cathode of the voltage regulating unit being electrically coupled to the secondary side of the isolation circuit, an anode of the voltage regulating unit being electrically coupled to a secondary ground, and a reference terminal of the voltage regulating unit being configured to provide a reference voltage; and
a second voltage dividing unit electrically coupled between the secondary side of the power conversion device and the secondary ground, and electrically coupled to the reference terminal of the voltage regulating unit.

14. The voltage regulating feedback circuit of claim 13, wherein the voltage regulating unit is configured to control a voltage level of the output voltage according to the reference voltage.

15. The voltage regulating feedback circuit of claim 13, wherein the second voltage dividing unit comprises:
a third voltage dividing resistor, a first terminal of the third voltage dividing resistor being electrically coupled to the output terminal, a second terminal of the third voltage dividing resistor being electrically coupled to the reference terminal of the voltage regulating unit; and
a fourth voltage dividing resistor, a first terminal of the fourth voltage dividing resistor being electrically coupled to the second terminal of the third voltage dividing resistor, a second terminal of the fourth voltage dividing resistor being electrically coupled to the secondary ground.
